(19) United States
(12) Patent Application Publication
(10) Pub. No.: US 2022/0155258 A1
(43) Pub. Date: May 19, 2022

(54) STAMPING QUALITY INSPECTION SYSTEM AND STAMPING QUALITY INSPECTION METHOD

(71) Applicant: INSTITUTE FOR INFORMATION INDUSTRY, Taipei (TW)

(72) Inventors: Ping-Feng WANG, Taipei (TW); Chiun-Sheng HSU, Taipei (TW); Hsiao-Yu WANG, Taipei (TW); Chih-Yuan CHEN, Taipei (TW)

(21) Appl. No.: 17/109,093

(22) Filed: Dec. 1, 2020

(30) Foreign Application Priority Data
Nov. 18, 2020 (TW) 109140385

(51) Int. Cl. G01N 29/14; G01N 29/46; G01N 29/44

(52) U.S. Cl. CPC G01N 29/14; G01N 29/46; G01N 2291/0289; G01N 2291/0234; G01N 29/4418

(57) ABSTRACT

A stamping quality inspection system includes a stamping device, a signal detecting element, and a processor. The signal detecting element is coupled to the stamping device. The signal detecting element is configured to detect a sound signal and a vibration signal of the stamping device. The processor is coupled to the signal detecting element. The processor is configured to determine a stamping operation time interval according to the sound signal and the vibration signal, to compare a sub sound signal of the sound signal and a sub vibration signal of the vibration signal in the stamping operation time interval to a pattern comparison module, so as to generate a quality inspection result.

### CROSS-REFERENCE TO RELATED APPLICATION

This application claims the priority benefit of TAIWAN Application serial no. 109140385, filed Nov. 18, 2020, the full disclosure of which is incorporated herein by reference.

### BACKGROUND

### Field of Invention

The invention relates to a stamping quality inspection system and a stamping quality inspection method. More particularly, the invention relates to a stamping quality inspection system and a stamping quality inspection method utilizing the sound signals and the vibration signals.

### Description of Related Art

In recent years, the stamping press industry has begun to develop in the direction of high precision and high productivity. The precision stamping press includes a high production capacity and a fast production speed, and the daily production capacity cannot be controlled by a full inspection method. Therefore, a real-time quality monitoring method is in need to efficiently pick out defective products and maintain efficient production quality.

### SUMMARY

An aspect of this disclosure is to provide a stamping quality inspection system that includes a stamping device, a signal detecting element, and a processor. The signal detecting element is coupled to the stamping device. The signal detecting element is configured to detect a sound signal and a vibration signal of the stamping device. The processor is coupled to the signal detecting element. The processor is configured to determine a stamping operation time interval according to the sound signal and the vibration signal, to compare a sub sound signal of the sound signal and a sub vibration signal of the vibration signal in the stamping operation time interval to a pattern comparison module, so as to generate a quality inspection result.

Another aspect of this disclosure is to provide a stamping quality inspection method. The stamping quality inspection method includes the following operations: detecting a sound signal and a vibration signal of a stamping device by a signal detecting element; determining a stamping operation time interval according to the sound signal and the vibration signal by a processor, and comparing a sub sound signal of the sound signal and a sub vibration signal of the vibration signal in the stamping operation time interval to a pattern comparison module by the processor to generate a quality inspection result.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic diagram illustrating a stamping quality inspection system according to some embodiments of the present disclosure.

FIG. 2 is a flowchart of a stamping quality inspection method according to some embodiments of the present disclosure.

FIG. 3 is a schematic diagram illustrating a detection signal according to some embodiments of the present disclosure.

FIG. 4 is a schematic diagram illustrating a sub sound signal according to some embodiments of the present disclosure.

FIG. 5 is a schematic diagram illustrating a sound signal under normal operation according to some embodiments of the present disclosure.

FIG. 6 is a schematic diagram illustrating a characteristic enhanced signal according to some embodiments of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention.

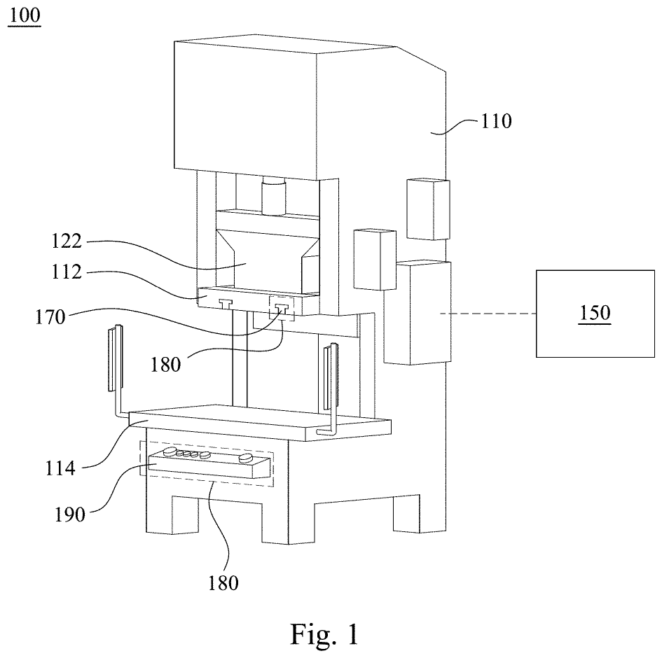

Reference is made to FIG. 1. FIG. 1 is a schematic diagram illustrating a stamping quality inspection system 100 according to some embodiments of the present disclosure. As illustrated in FIG. 1, the stamping quality inspection system 100 includes a stamping device 110, a signal detecting element 180, and a processor 150. The signal detecting element 180 includes a vibration detecting element 170 and a sound detecting element 190. In the connection relationship, the stamping device 110 is coupled to the vibration detecting element 170 and the sound detecting element 190. The processor 150 is coupled to the vibration detecting element 170 and the sound detecting element 190.

In some embodiments, the stamping device 110 includes an upper mold 112 and a lower mold 114. In some embodiments, the vibration detecting element 170 is located at the upper mold 112, the punch 122, or the lower mold 114. When the vibration detecting element 170 is located at the lower mold 114, there is no need to replace the vibration detecting element 170 with the replacement of the upper mold 112 and the punch 122, which is a preferred embodiment. In some embodiments, the sound detecting element 190 is stick to or close to the stamping device 110. When the sound detecting element 190 is stick to the stamping device 110, a better sound signal can be obtained, which is a better embodiment. The stamping quality inspection system 100 as illustrated in FIG. 1 is for illustrative purposes only, and the embodiments of the present disclosure are not limited thereto.

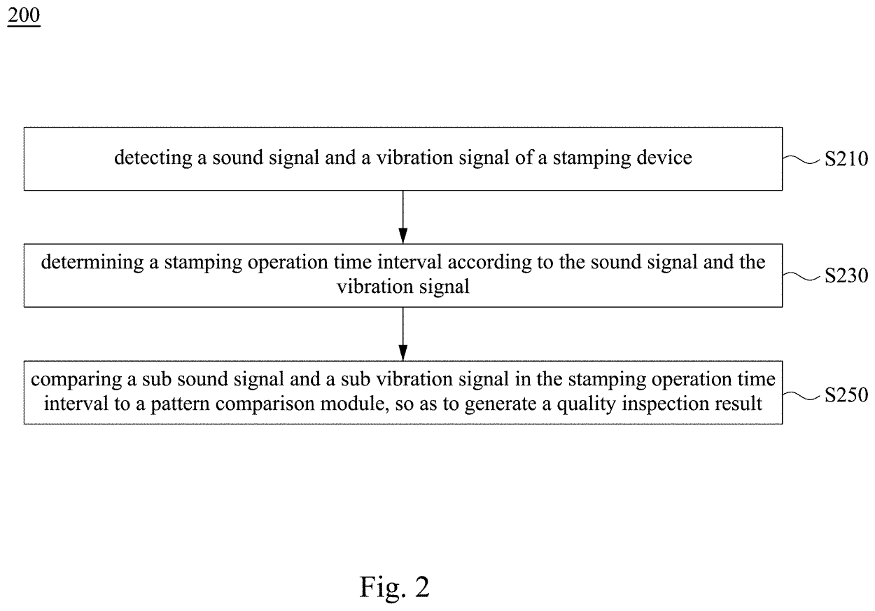

The operation method of the stamping quality inspection system 100 will be described with reference to FIG. 2 in the following.

Reference is made to FIG. 2. FIG. 2 is a flowchart of a stamping quality inspection method 200 according to some embodiments of the present disclosure. The embodiments of the present disclosure are not limited thereto.

It should be noted that the stamping quality inspection method 200 can be applied to a system that is the same as or similar to the structure of the stamping quality inspection system 100 as shown in FIG. 1. To simplify the description below, the embodiments shown in FIG. 1 will be used as an example to describe the method according to an embodiment of the present disclosure. However, the present disclosure is not limited to application to the embodiments shown in FIG. 1.

It should be noted that, in some embodiments, the stamping quality inspection method 200 may be implemented as a computer program, and the computer program is stored in a non-transitory computer readable medium, so that a computer, an electronic device, or the processor 150 in the stamping quality inspection system 100 in FIG. 1 reads the recording medium and executes the operation method. The processor can be consisted by one or more wafers. The computer program can be stored in a non-transitory computer readable medium such as a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this invention pertains.

Furthermore, it should be noted that, the operations of the stamping quality inspection method 200 mentioned in the present embodiment can be adjusted according to actual needs except for those whose sequences are specifically stated, and can even be executed simultaneously or partially simultaneously.

Furthermore, in different embodiments, these operations may also be adaptively added, replaced, and/or omitted.

Reference is made to FIG. 2. The stamping quality inspection method 200 includes the following operations.

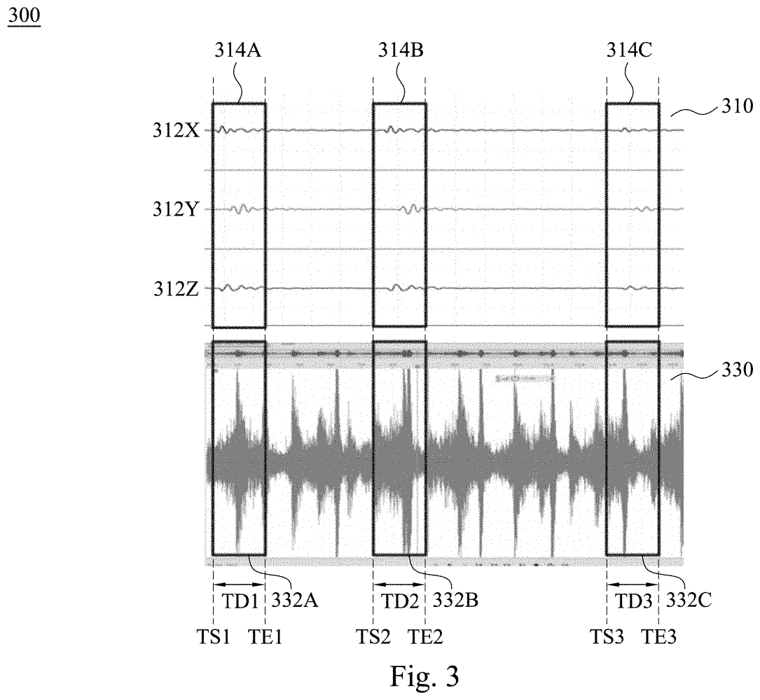

In operation S210, a sound signal and a vibration signal of the stamping device is detected. Reference is made to FIG. 1 together, in some embodiments, operation S210 is operated by the sound detecting element 190 and the vibration detecting element 170 as illustrated in FIG. 1. The detailed operation method of operation S210 will be described below with reference to FIG. 3.

Reference is made to FIG. 3. FIG. 3 is a schematic diagram illustrating a detection signal 300 according to some embodiments of the present disclosure. The detection signal 300 includes a sound signal 330 and a vibration signal 310. In some embodiments, the sound signal 330 is obtained by the sound detecting element 190, and the vibration signal 310 is obtained by the vibration detecting element 170. In some embodiments, the vibration signal 310 includes the X-axis vibration signal 312X, the Y-axis vibration signal 312Y, and the Z-axis vibration signal 312Z. It should be noted that, although the three axis vibration signal is shown in FIG. 3, however, in some embodiments, only the vibration signal of one of the three axes is required to perform subsequent signal processing and quality inspection.

Reference is made to FIG. 2 again. In operation S230, the stamping operation time interval is determined according to the sound signal and the vibration signal. Reference is made to FIG. 1 together, in some embodiments, operation S230 is operated by the processor 150 as illustrated in FIG. 1. The detailed operation method of operation S230 will be described with reference FIG. 3 in the following.

In some embodiments, after the processor 150 receives the vibration signal 310 obtained by the vibration detecting element 170 and the sound signal 330 obtained by the sound detecting element 190, the processor 150 determines the starting time and the ending time according to the vibration signal.

Reference is made to FIG. 3 together. In some embodiments, the processor 150 converts the sound signal 330 into a sound spectral density graph, and converts the vibration signal 310 into the vibration spectral density graph. In some embodiments, the processor 150 extracts the frequency spectrum from the amplitude information of the vibration signal 310 using fast Fourier transform FFT, and the processor 150 converts the frequency spectrum into a power spectral density to generate a vibration spectral density graph. The sound spectral density graph generation method is similar to the method of generating the vibration spectral density graph mentioning above, and will not be described in detail here.

The processor 150 further determines the starting time and the ending time after the root mean square value (RMS) of a window exceeds a certain set threshold value according to the vibration waveform signal.

For example, the processor 150 divides the vibration waveform signal graph into several windows. The processor 150 calculates the root mean square value of several windows. Assuming that the first window and the second window are adjacent, and the second window is located after the first window, and the second window is later than the first window in chronological order. The processor 150 calculates the difference value between the root mean square value of the first window and the root mean square value of the second window.

When the root mean square value of the second window is larger than the root mean square value of the first window, and the difference value between the root mean square value of the first window and the root mean square value of the second window is larger than the first root mean square threshold value, the processor 150 determines that the time point between the first window and the second window is the starting time.

On the other hand, when the root mean square value of the second window is smaller than the root mean square value of the first window, and a difference value between the root mean square value of the first window and root mean square value of the second window is larger than a second root mean square threshold value, the processor 150 determines that the time point between the first window and the second window is the ending time.

In some embodiments, after the processor 150 obtains the starting time TS1 and the ending time TE1, the processor 150 obtains the stamping operation time interval TD1 between the starting time TS1 and the ending time TE1. Similarly, after the processor 150 obtains the starting time TS2 and the ending time TE2, the processor 150 obtains the stamping operation time interval TD2 between the starting time TS2 and the ending time TE2. After the processor 150 obtains the starting time TS3 and the ending time TE3, the processor 150 obtains the stamping operation time interval TD3 between the starting time TS3 and the starting time TS1. The numbers and positions of the starting times TS1 to TS3 and the ending times TE1 to TE3 mentioned above are for illustrative purposes only, and the embodiments of the present disclosure are not limited thereto.

In some embodiments, the acquisition of the starting time and acquisition of the ending time are synchronized with the detection of the sound signal and the vibration signal. In some embodiments, after obtaining the starting time and the ending time, the processor 150 starts to perform subsequent operations to recognize the stamping quality in real time.

In operation S250, the sub sound signal and the sub vibration signal in the stamping operation time interval is compared to the pattern comparison module to generate a quality inspection result. Reference is made to FIG. 1 together. In some embodiments, the operation S230 can be executed by the processor 150 in FIG. 1. The detailed operation method of operation S230 will be described below with reference to FIG. 3 to FIG. 5.

Reference is made to FIG. 3 together. The processor 150 captures the sub sound signal 332A and the sub vibration signal 314A in the stamping operation time interval TD1 according to the starting time TS1 and the ending time TE1. Similarly, the processor 150 captures the sub sound signal 332B and the sub vibration signal 314B in the stamping operation time interval TD2 according to the starting time TS2 and the ending time TE2. The processor 150 captures the sub sound signal 332C and the sub vibration signal 314C in the stamping operation time interval TD3 according to the starting time TS3 and the ending time TE3.

In some embodiments, before the operation of the comparison to the pattern comparison module, the processor 150 pre-process the sub sound signals 332A to 332C and the sub vibration signals 314A to 314C first. In detail, the processor 150 processes the sub sound signals 332A to 332C and the sub vibration signals 314A to 314C through wavelet analysis (Wavelet), the short-time Fourier transform (STFT), the Mel frequency cepstral coefficient (MFCC), and other signal processing to generate the spectrum signals, so as to generate the sub sound characteristic value of the sub sound signal 332A, the sub sound characteristic value of the sub sound signal 332B, the sub sound characteristic value of the sub sound signal 332C, the sub vibration characteristic value of the sub vibration signal 314A, the sub vibration characteristic value of the sub vibration signal 314B and the sub vibration characteristic value of the sub vibration signal 314C.

The following will take the sub sound signal 332A and the sub vibration signal 314A as examples for description. The methods of comparing the sub sound signal 332B, sub sound signal 332C, sub vibration signal 314B, and sub vibration signal 314C to the pattern comparison module to generate a quality inspection result are similar to those of the sub sound signal 332A and sub vibration signal 314, and may not be explained in detail here.

In some embodiments, the pattern comparison module includes the sound comparison module and the vibration comparison module. The pattern comparison module is a pattern recognition model generated according to the sound signal spectrum (such as audio) of the normal sound and the normal vibration signal spectrum (such as vibration frequency) of the previous training. After inputting the sub sound spectrum characteristic value of the sub sound signal to the pattern comparison module, the pattern comparison module generates a sound comparison confidence level according to the comparison result. After inputting the sub vibration frequency spectrum characteristic value of the sub vibration signal to the pattern comparison module, the pattern comparison module generates a vibration comparison confidence level according to the comparison result. In some embodiments, the sound comparison confidence level and vibration comparison confidence level mentioning above are based on the average value of the absolute value of the correlation coefficient between the input characteristic value data and the characteristic value data marked as normal during training.

In some embodiments, when at least one of the sound comparison confidence level or the vibration comparison confidence level is greater than the confidence level threshold value, the processor 150 determines that the stamping operation in the stamping time interval is bad or good according to the determination result that the confidence level is greater than the confidence level threshold value or not.

For example, the processor 150 inputs the sub sound signal 332A to the sound comparison module to generate a sound comparison confidence level. The processor 150 inputs the sub vibration signal 314A corresponding to the sub sound signal 332A to the vibration comparison module to generate a vibration comparison confidence level. It should be noted that, in some embodiments, corresponding refers to the sub sound signal and the sub vibration signal generated at the same time. For example, both of the sub sound signal 332A and the corresponding sub vibration signal 314A are located between the starting time TS1 and the ending time TE1 as shown in FIG. 3.

When the sound comparison confidence level is larger than the confidence level threshold value and the vibration comparison confidence level is smaller than the confidence level threshold value, whether the stamping operation in the stamping operation time interval TD1 is bad or good is determined according to the determination result of the sound comparison module. On the other hand, when the sound comparison confidence level is smaller than the confidence level threshold value and the vibration comparison confidence level is larger than the confidence level threshold value, whether the stamping operation in the stamping operation time interval TD1 is bad or good is determined according to the determination result of the vibration comparison module. When both of the sound comparison confidence level and the vibration comparison confidence level are larger than the confidence level threshold value and the determination results are consistent, whether the stamping operation in the stamping operation time interval TD1 is bad or good is determined according to the determination results of the sound comparison module and the vibration comparison module.

On the other hand, when both of the sound comparison confidence level and the vibration comparison confidence level are not larger than the confidence level threshold value, or when the both of the sound comparison confidence level and the vibration comparison confidence level are larger than the confidence level threshold value but the comparison results are not consistent, the processor 150 merges the sub sound characteristic value of the sub sound signal and the sub vibration characteristic value of the sub vibration signal according to the sound comparison confidence level and the vibration comparison confidence level, so as to generate the merged signal. Then, the processor 150 generates the quality inspection result according to the merged signal.

However, in some other embodiments, whether the sound comparison confidence level and the vibration comparison confidence level are larger than the confidence level threshold value or not, the processor 150 generates the merged signal and generates the quality inspection result according to the merged signal.

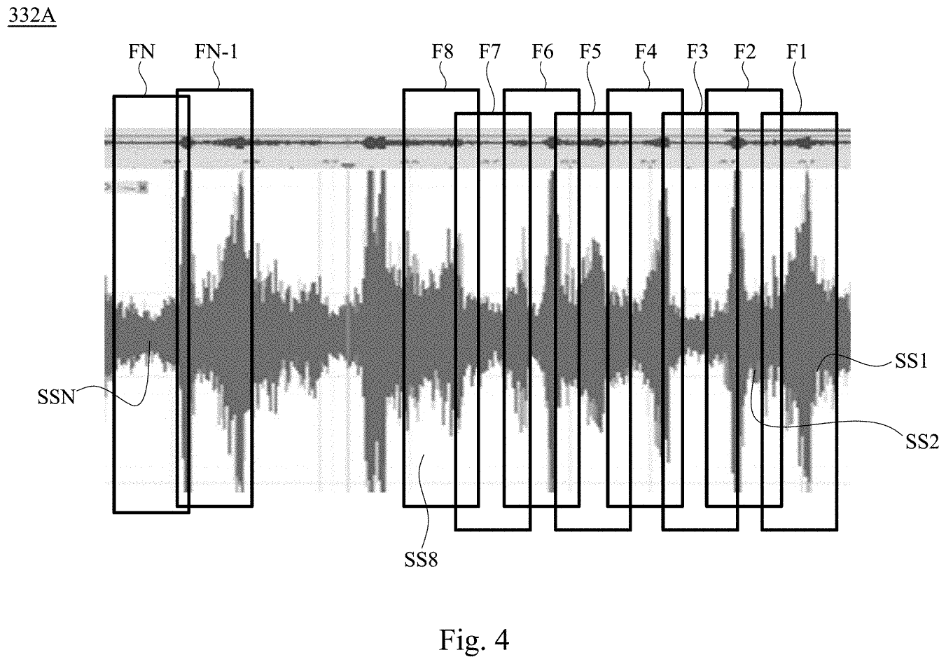

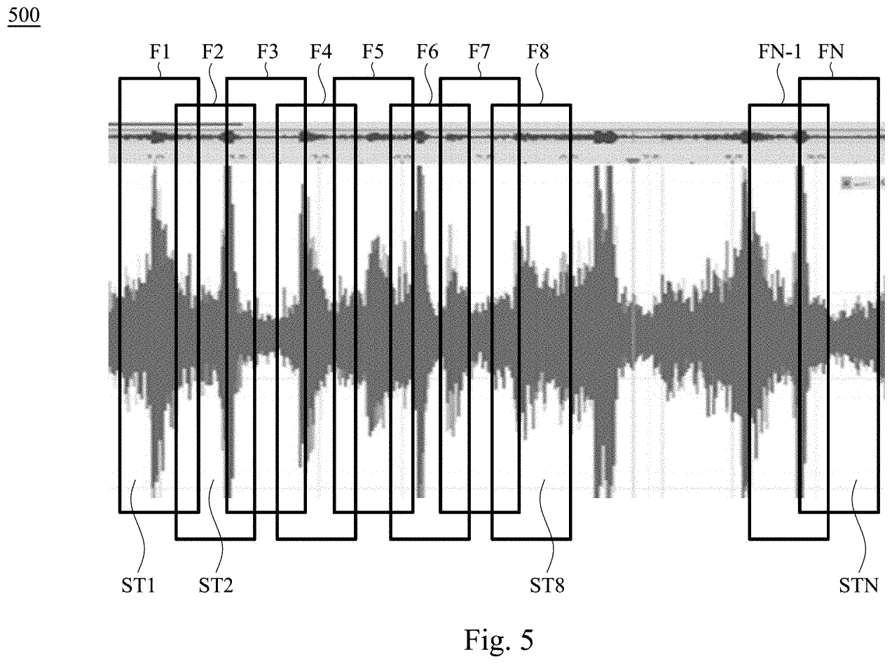

Reference is made to FIG. 4 and FIG. 5 at the same time. FIG. 4 is a schematic diagram illustrating a sub sound signal 332A according to some embodiments of the present disclosure. FIG. 5 is a schematic diagram illustrating a sound signal 500 under normal operation according to some embodiments of the present disclosure. The following will take the sub sound signal 332A as an example to describe the signal mergence. The merging method of the sub sound signals 332B, 332C and the sub vibration signals 314A to 314C is similar to that of the sub sound signal 332A and will not be described in detail here.

As illustrated in FIG. 4, in some embodiments, according to several windows F1 to FN, the sub sound signal 332A can be separated into several window sound signals SS1 to SSN. As illustrated in FIG. 5, in some embodiments, according to several windows F1 to FN, the sound signal 500 in normal operation can be divided into several window standard sound signals ST1 to STN. Similarly, according to several windows F1 to FN, the sub vibration signal 314A can be divided into several window vibration signals (not shown). Each of the several window sound signals SS1 to SSN mentioning above corresponds to one of the several window vibration signals respectively. In detail, the window sound signal SS1 located in the window F1 corresponds to the window vibration signal located in the window F1, and the rest can be deduced by analogy. In some embodiments, the windows F1 of different signals are in the same time interval in time series.

Reference is made to FIG. 4 and FIG. 5 together. In some embodiments, the processor 150 compares the window sound signal SS1 located in the window F1 to the window standard sound signal ST1, which is also located in the window F1, to generate the window sound comparison confidence level corresponding to the window F1. The processor 150 compares the window sound signal SS2 in the window F2 to the window standard sound signal ST2 in the window F2 to generate a window sound comparison confidence level corresponding to the window F2. Similarly, the processor 150 compares the window vibration signal (not shown) in the window F1 to the vibration signal in the window F1 of the window vibration signal (not shown) under the normal operation to generate a window vibration comparison confidence level corresponding to the window F1. The rest can be deduced by analogy and will not be described in detail here.

The calculation methods of the window sound comparison confidence levels and the window vibration comparison confidence levels in the other windows F2 to FN are the same as the paragraphs mentioning above, and will not be described in detail here. Accordingly, the processor 150 calculates the several window sound comparison confidence levels and the several window vibration comparison confidence levels of the several windows F1 to FN.

In some embodiments, the sound comparison confidence level and the vibration comparison confidence level can be generated using methods such as Euclidean distance and correlation coefficient.

In some embodiments, the processor 150 merges the window sound signal SS1 and the window vibration signal corresponding to the window F1 according to the window sound comparison confidence level of the window F1 and the window vibration comparison confidence level of the window F1. Similarly, the processor 150 merges the window vibration signal of the window F2 and the window sound signal of the window F2 according to the window vibration comparison confidence level of the window vibration signal of the window F2 and the window sound comparison confidence level of the window sound signal of the window F2. The merging methods of the reset of the windows are deduced in analogy.

In some embodiments, before merging operation, the processor 150 performs characteristic enhancement operation to the sub sound signal and sub vibration signal.

In detail, when one of the several window sound comparison confidence levels is smaller than the comparison threshold value, the characteristic value of the signal of the one of several window sound comparison confidence levels with the confidence level smaller than the comparison threshold value is enhanced. When one of the several window vibration comparison confidence levels is smaller than the comparison threshold value, the characteristic value of the signal of the one of the several window vibration comparison confidence levels with the confidence level smaller than the comparison threshold value is enhanced. In some embodiments, the comparison threshold value is 0.4, but the embodiments of the present disclosure are not limited thereto.

When the comparison confidence level is smaller than the comparison threshold value, it refers that the characteristic difference between the signal of the window and the normal signal of the window is large. Therefore, the accuracy of quality inspection can be increased by enhancing the characteristic data. The normal signal refers to the sub sound signal and/or the sub vibration signal determined as normal stamping quality by the processor 150.

For example, when the processor 150 determines that the window sound comparison confidence level of the window F1 is smaller than the confidence level threshold value, the processor 150 enhances the window sound characteristic value of the window sound signal of the window F1. The enhancement methods include multiplying the signal in the window by a weight value, or using functions such as Softmax and Sigmoid for enhancement.

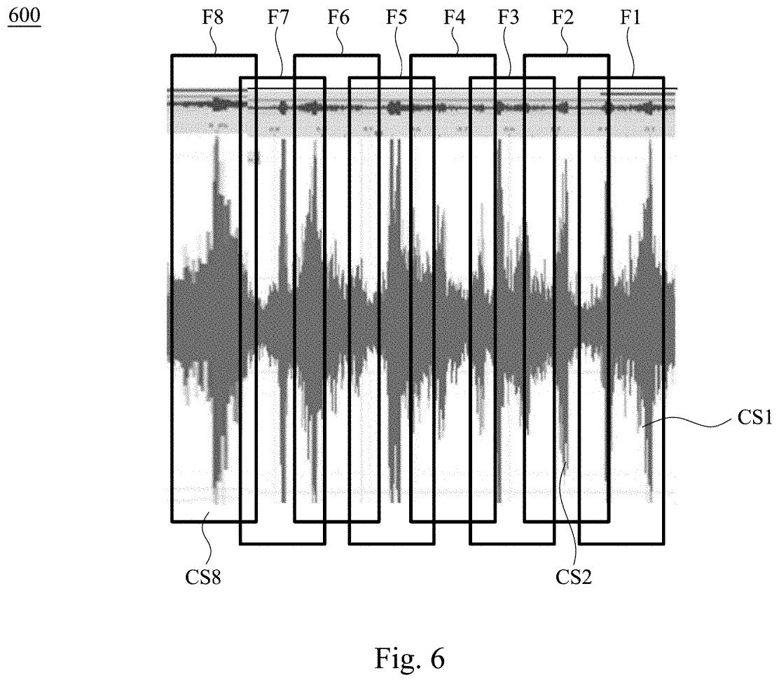

Reference is made to FIG. 6. FIG. 6 is a schematic diagram illustrating a characteristic enhanced signal 600 according to some embodiments of the present disclosure. The characteristic enhanced signal 600 in FIG. 6 includes the characteristic enhanced sub signal CS1 of the window F1 to the characteristic enhanced sub signal CS8 of the window F8.

In some embodiments, the processor 150 then converts the sub sound signal and the sub vibration signal into the time-frequency graph data for merging operation.

In some embodiments, when performing the merging operation, the processor 150 uses the probability method or the comparison method. The two merging methods mentioning above are for illustrative purposes only, and the embodiments of the present disclosure are not limited thereto.

The method of merging operation using the probability method will be described in the following. In some embodiments, the processor 150 uses the Softmax function. The processor 150 inputs the window vibration comparison confidence level and the window sound comparison confidence level corresponding to the window F1 into the Softmax function, so as to generate the first weight value and the second weight value that add up to 1. The first weight value corresponds to the window sound comparison confidence level of the window F1, and the second weight value corresponds to the window vibration comparison confidence level of the window F1.

The processor 150 then multiplies the window sound characteristic value of the window sound signal of the window F1 by the first weight value and multiplies the window vibration characteristic value of the window vibration signal of the window F1 by the second weight value, and the weighted signals are added to generate the merged sub signal of the window F1. The merging methods of the rest of the windows F2 to FN can be deduced by analogy and will not be described in detail here.

Then, the processor 150 merges the merged sub signals of several windows according to the original window order to generate the merged signal.

The method of merging operation using the comparison method will be described in the following. In some embodiments, the processor 150 uses the ensemble algorithm to perform voting, and the characteristic value data with a higher confidence level is used for the merging operation. For example, if the vibration comparison confidence level corresponding to the window F1 is lower than the sound comparison confidence level corresponding to the window F1, the processor 150 selects the window sound signal SS1 in the window F1 as the merged sub signal of the window F1. On the other hand, if the window sound comparison confidence level corresponding to the window F1 is lower than the window vibration comparison confidence level corresponding to the window F1, the processor 150 selects the window vibration signal in the window F1 as the merged sub signal of the window F1. Similarly, the processor 150 compares and selects the window vibration comparison confidence level and sound comparison confidence level from window F2 to window FN one by one, so as to generate the merged sub signals of each window.

Then, the processor 150 merges the merged sub signals of several windows F1 to FN according to the original window order to generate the merged signal.

The above description takes the integration of windows as an example. However, in some other embodiments, when the processor 150 performs the merging operation, according to the sound comparison confidence level of the sub sound signal in the stamping operation time interval TD1 and the vibration comparison confidence level of the sub vibration signal in the stamping operation time interval TD1 directly, the probability method or the comparison method can be used for merging operation without processing window by window.

In some embodiments, the processor 150 inputs the merged signal to the hidden Markov model HMM for abnormal diagnosis and identification, and the processor 150 generates the quality inspection results.

In some embodiments, the processor 150 may be a server or other devices. In some embodiments, the processor 150 can be a server, a circuit, a central processing unit (CPU), or a microprocessor (MCU) with functions such as storage, calculation, data reading, receiving signals or messages, and transmitting signals or messages, or other devices with equivalent functions. In some embodiments, the vibration detecting element 170 may be an accelerometer and other elements or circuits with vibration signal detection and capture functions or similar functions. The sound detecting element 190 may be an element having functions of detecting and capturing sound signals, such as a microphone, or other elements or circuits with similar functions.

According to the embodiment of the present disclosure, it is understood that the embodiment of the present disclosure is to provide a stamping quality inspection system and a stamping quality inspection method, during the metal stamping process, the sound signal and the vibration signal are simultaneously captured and compared and analyzed so as to detect the impact and/or the punch of the stamping press on the metal plate during the metal stamping process, and the computer machine learning algorithm is used for quality judgment, in order to save the possibility of manual inspection and shipment of defective products. Furthermore, by merging the characteristic value of the vibration signal and the sound signal, and then identifying the similarity between the merged signal and the normal signal, the abnormal quality of stamping products can be identified more accurately.

In a noisy live environment, a lot of interference and noise exist during the sound signal collection. Utilizing the characteristics of stamping, the vibration amplitude of the vibration signal is compared to confirm the moment of stamping operation, and the interval of the sound signal is synchronously captured for analysis, which can avoid signal interference and reduce the analysis and comparison data time of the stamping quality inspection system motion.

In this document, the term “coupled” may also be termed as “electrically coupled”, and the term “connected” may be termed as “electrically connected”. “coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In addition, the above illustrations comprise sequential demonstration operations, but the operations need not be performed in the order shown. The execution of the operations in a different order is within the scope of this disclosure. In the spirit and scope of the embodiments of the present disclosure, the operations may be increased, substituted, changed, and/or omitted as the case may be.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A stamping quality inspection system, comprising:
a stamping device;
a signal detecting element, coupled to the stamping device, configured to detect a sound signal and a vibration signal of the stamping device; and
a processor, coupled to the signal detecting element, configured to determine a stamping operation time interval according to the sound signal and the vibration signal, to compare a sub sound signal of the sound signal and a sub vibration signal of the vibration signal in the stamping operation time interval to a pattern comparison module, so as to generate a quality inspection result.

2. The stamping quality inspection system of claim 1, wherein the signal detecting element comprises:
a sound detecting element, configured to detect the sound signal; and
a vibration detecting element, configured to detect the vibration signal.

3. The stamping quality inspection system of claim 1, wherein the processor is further configured to determine a starting time and an ending time according to the sound signal and the vibration signal, and to capture the sub sound signal and the sub vibration signal according to the starting time and the ending time.

4. The stamping quality inspection system of claim 3, wherein the processor is further configured to convert the sound signal and the vibration signal into a sound spectral density graph and a vibration spectral density graph respectively, and to determine the starting time and the ending time according to a root mean square value of the sound spectral density graph and a root mean square value of the vibration spectral density graph.

5. The stamping quality inspection system of claim 4, wherein the processor is further configured to calculate a first root mean square value of the vibration signal in a first window and a second root mean square value of the vibration signal in a second window, and to calculate a difference value between the first root mean square value and the second root mean square value, wherein the first window is a previous window of the second window, and when the second root mean square value is larger than the first root mean square value and the difference value is larger than a first root mean square threshold value, the processor determines the starting time, and when the second root mean square value is smaller than the first root mean square value and the difference value is larger than a second root mean square threshold value, the processor determines the ending time.

6. The stamping quality inspection system of claim 1, wherein the processor is further configured to compare the sub sound signal and the sub vibration signal to the pattern comparison module to generate a sound comparison confidence level and a vibration comparison confidence level, and when both of the sound comparison confidence level and the vibration comparison confidence level are not larger than a confidence level threshold value, the processor is configured to merge a sub sound characteristic value of the sub sound signal and a sub vibration characteristic value of the sub vibration signal according to the sound comparison confidence level and the vibration comparison confidence level respectively, to generate a merged signal, and to generate the quality inspection result according to the merged signal.

7. The stamping quality inspection system of claim 6, wherein the sub sound signal comprises a plurality of window sound signals, the sub vibration signal comprises a plurality of window vibration signals, wherein the processor is further configured to merge each of the plurality of window sound signals with a corresponding one of the plurality of window vibration signals respectively, so as to generate the merged signal.

8. The stamping quality inspection system of claim 7, wherein the processor is further configured to multiply a sub sound characteristic value of the sub sound signal by a first weight value and to multiply a sub vibration characteristic value of the sub vibration signal by a second weight value before merging to generate the merged signal, wherein a sum of the first weight value and the second weight value is 1, and the first weight value and the second weight value are generated according to the sound comparison confidence level and the vibration comparison confidence level.

9. The stamping quality inspection system of claim 7, wherein the processor is further configured to operate a merging operation with an ensemble algorithm to generate the merged signal, wherein a first window sound signal of the plurality of window sound signals corresponds to a first window vibration signal of the plurality of window vibration signals, wherein the processor is further configured to select the one with a larger confidence level between the first window sound signal and the first window vibration signal to generate the merged signal.

10. The stamping quality inspection system of claim 6, wherein the processor is further configured to generate the quality inspection result according to a hidden Markov model and the merged signal.

11. A stamping quality inspection method, comprising:
detecting a sound signal and a vibration signal of a stamping device by a signal detecting element;
determining a stamping operation time interval according to the sound signal and the vibration signal by a processor; and
comparing a sub sound signal of the sound signal and a sub vibration signal of the vibration signal in the stamping operation time interval to a pattern comparison module by the processor to generate a quality inspection result.

12. The stamping quality inspection method of claim 11, further comprising:
determining a starting time and an ending time according to the sound signal and the vibration signal; and
capturing the sub sound signal and the sub vibration signal according to the starting time and the ending time.

13. The stamping quality inspection method of claim 12, further comprising:
converting the sound signal and the vibration signal into a sound spectral density graph and a vibration spectral density graph respectively; and
determining the starting time and the ending time according to a root mean square value of the sound spectral density graph and a root mean square value of the vibration spectral density graph.

14. The stamping quality inspection method of claim 13, further comprising:
calculating a first root mean square value of the vibration signal in a first window and a second root mean square value of the vibration signal in a second window;
calculating a difference value between the first root mean square value and the second root mean square value, wherein the first window is a previous window of the second window;
determining the starting time when the second root mean square value is larger than the first root mean square value and the difference value is larger than a first root mean square threshold value; and
determining the ending time when the second root mean square value is smaller than the first root mean square value and the difference value is larger than a second root mean square threshold value.

15. The stamping quality inspection method of claim 11, further comprising:
comparing the sub sound signal and the sub vibration signal to the pattern comparison module to generate a sound comparison confidence level and a vibration comparison confidence level;
merging a sub sound characteristic value of the sub sound signal and a sub vibration characteristic value of the sub vibration signal according to the sound comparison confidence level and the vibration comparison confidence level respectively, so as to generate a merged signal; and
generating the quality inspection result according to the merged signal.

16. The stamping quality inspection method of claim 15, wherein the sub sound signal comprises a plurality of window sound signals, the sub vibration signal comprises a plurality of window vibration signals, wherein the stamping quality inspection method further comprises:
calculating a plurality of window sound comparison confidence levels of the plurality of window sound signals and a plurality of window vibration comparison confidence levels of the plurality of window vibration signals; and
enhancing a window sound characteristic value of one of the plurality of window sound comparison confidence levels when the one of the plurality of window sound comparison confidence levels is smaller than a comparison threshold value or enhancing a window vibration characteristic value of one of the plurality of window vibration comparison confidence levels when the one of the plurality of window vibration comparison confidence levels is smaller than a comparison threshold value.

17. The stamping quality inspection method of claim 15, wherein the sub sound signal comprises a plurality of window sound signals, the sub vibration signal comprises a plurality of window vibration signals, wherein the stamping quality inspection method further comprises:
merging each of the plurality of window sound signals with a corresponding one of the plurality of window vibration signals respectively, to generate the merged signal.

18. The stamping quality inspection method of claim 17, wherein a first window sound signal of the plurality of window sound signals corresponds to a first window vibration signal of the plurality of window vibration signals, and the first window sound signal comprises a first window sound comparison confidence level, the first window vibration signal comprises a first window vibration comparison confidence level, the stamping quality inspection method further comprises:
generating a first weight value and a second weight value according to the first window sound comparison confidence level and the first window vibration comparison confidence level respectively, wherein a sum of the first weight value and the second weight value is 1; and
multiplying a window sound characteristic value of the first window sound signal by the first weight value and multiplying a window vibration characteristic value of the first window vibration signal by the second weight value before merging to generate a first merged sub signal of the merged signal.

19. The stamping quality inspection method of claim 17, wherein a first window sound signal of the plurality of window sound signals corresponds to a first window vibration signal of the plurality of window vibration signals, and the first window sound signal comprises a first window sound comparison confidence level, the first window vibration signal comprises a first window vibration comparison confidence level, wherein the stamping quality inspection method further comprises:
selecting the first window sound signal to generate a first merged sub signal of the merged signal when the first window sound comparison confidence level is larger than the first window vibration comparison confidence level; and
selecting the first window vibration signal to generate the first merged sub signal of the merged signal when the first window sound comparison confidence level is not larger than the first window vibration comparison confidence level.

20. The stamping quality inspection method of claim 15, further comprising:
generate the quality inspection result according to a hidden Markov model and the merged signal.
